(19) United States
(12) Patent Application Publication
(10) Pub. No.: US 2021/0344371 A1
(43) Pub. Date: Nov. 4, 2021

(54) SYSTEM FOR OPTIMIZED USE OF DEVICE WITH TOOL DRIVEN BY A PRIME MOVER

(71) Applicant: Walbro LLC, Tucson, AZ (US)

(72) Inventor: Gerald J. LaMarr, Jr., Bay City, MI (US)

(21) Appl. No.: 17/280,949

(22) PCT Filed: Oct. 10, 2019
(86) PCT No.: PCT/US2019/055576

§ 371 Date: Mar. 29, 2021

Related U.S. Application Data
(60) Provisional application No. 62/746,232, filed on Oct. 16, 2018.

(51) Int. Cl. H04B 1/3877; G01C 21/00; G01S 19/14; A01B 69/00

(52) U.S. Cl. CPC H04B 1/3877; A01B 69/00; G01S 19/14; G01C 21/005

(57) ABSTRACT

In at least some implementations, a method of directing use of a handheld device including a tool which is used to perform work on a property, includes analyzing the property to determine at least one area in which work is to be performed, determining a starting point for the work, determining an ending point for the work, determining a work path to be taken by a user between the starting point and the ending point, and communicating the work path to a user of the handheld device. The communication may occur via a screen of a portable electronic device, like a phone, tablet or a dedicated display for the device.

### REFERENCE TO RELATED APPLICATIONS

This application claims the benefit of U.S. Provisional Application Ser. No. 62/746,232 filed on Oct. 16, 2018 the entire contents of which are incorporated herein by reference in its entirety.

### TECHNICAL FIELD

The present disclosure relates generally to devices having a tool driven by a prime mover, and including a mount and control system for an electronic device.

### BACKGROUND

Various lawn and garden tools may be used on a given property to, for example, mow the lawn, trim bushes or trees, blow or remove debris, edge the perimeter of a lawn and trim weeds or tall grasses. A user of such tools walks or moves along a path that may be haphazard or inefficient, and which might not take into account desired starting and ending points. This wastes time, fuel and/or electricity, and creates unnecessary emissions or other waste. Further, such tools do not have a display by which information may be communicated to a user, or sensors or other devices by which information about use of the tools may be determined and stored or tracked.

### SUMMARY

In at least some implementations, a method of directing use of a handheld device including a tool which is used to perform work on a property, includes analyzing the property to determine at least one area in which work is to be performed, determining a starting point for the work, determining an ending point for the work, determining a work path to be taken by a user between the starting point and the ending point, and communicating the work path to a user of the handheld device. The communication may occur via a screen of a portable electronic device, like a phone, tablet or a dedicated display for the device.

In at least some implementations, a separate work path is provided for each tool for which work is to be performed on the property, and each work path may be displayed simultaneously or one at a time on a display.

The method may also include tracking the position of a user and displaying the position of the user on a display and relative to the work path. In at least some implementations, the position of a user is tracked and comparing the tracked position of the user to a desired position of the user. An alert may be displayed to the user when the user is more than a threshold distance from the desired position. And/or the actual path of movement of a user of the device may be stored to memory, such as memory on the portable device or associated with and accessed by the controller.

In at least some implementations, a handheld apparatus includes a support including one or more handles arranged to be grasped by a user, a prime mover carried by the support, a tool carried by the support and driven by the prime mover, and a mount carried by the support to receive and releasably retain a portable electronic device having a display and a processor that causes information relating to a work path to be shown on the display for viewing by a user of the apparatus. In at least some implementations, a display is provided that includes information about multiple work paths with at least one work path provided for each tool to be used on the property. An entire work path may be provided to a display at one time, and all or discrete segments of the work path may be displayed. The multiple work paths may be provided on the display with different indicia so that the individual work paths can be distinguished from each other.

In at least some implementations, the device includes a controller that is arranged for wired or wireless connection to the processor of the electronic device. In at least some implementations, one of the controller and the electronic device includes a GPS unit or GPS chipset by which the location of the apparatus can be determined. In at least some implementations, the location of the apparatus is shown by an indicator on a display of the electronic device. The display may include information about a property at which the apparatus is located. And the display may include a computer generated image or a satellite image of the property at which the apparatus is located. The GPS unit or GPS chipset may provide information relating to an actual path of movement of the apparatus. The device may include memory in which is stored the work path and one or both of the current position of the apparatus or actual path of movement of the apparatus.

In at least some implementations, the work path includes a starting point and an ending point and an optimized path between the starting point and ending point. The starting point and ending point may be the same location, such as a garage or a location on a street where a vehicle may be parked.

### BRIEF DESCRIPTION OF THE DRAWINGS

The following detailed description of certain embodiments and best mode will be set forth with reference to the accompanying drawings, in which:

FIG. 1 is a perspective view of a portion of an apparatus showing a support, a mount and a portable electronic device releasably retained by the mount;

FIG. 2 is a perspective view of the apparatus showing a rear side of the mount and portable electronic device, and an engine carried by the support;

FIG. 3 is a perspective view of the apparatus including a display on the electronic device of a cutting path to be followed by a user; and

FIG. 4 is an enlarged view of the display shown in FIG. 3.

### DETAILED DESCRIPTION

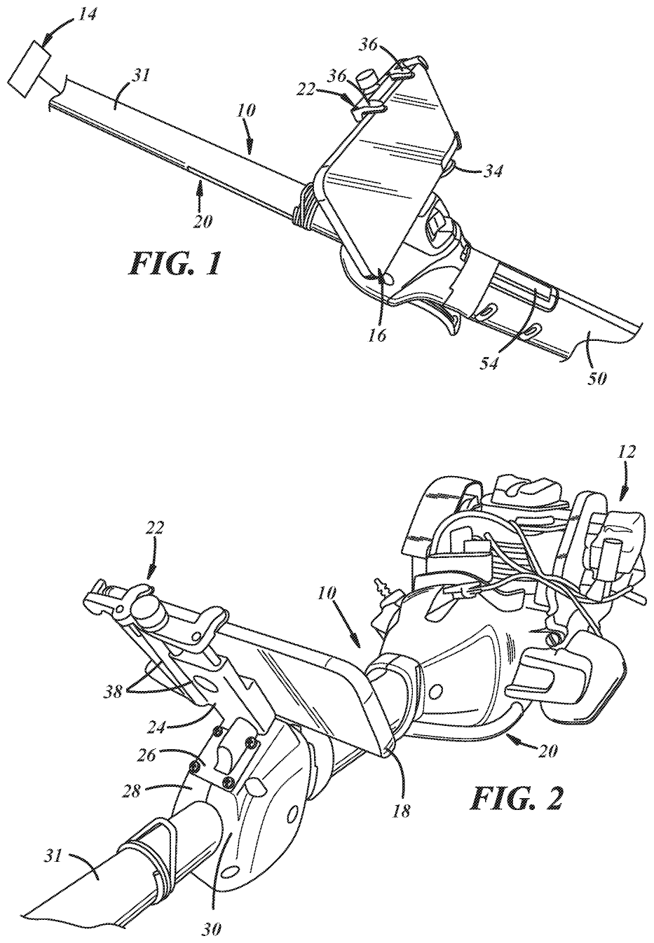

Referring in more detail to the drawings, FIGS. 1 and 2 illustrate an apparatus 10 having a prime mover 12, a tool 14 driven by the prime mover 12 to perform work, and an interactive display 16 which may be part of a portable electronic device 18 that may be removably attached to the apparatus 10. Some non-limiting examples of the tool 14 include a string or blade trimmer, air blower, lawn/garden edger, lawn mower, snow thrower, pole saw, ground tiller or cultivator, scythe, hedge trimmer, rotary brush or sweeper, or the like. Example prime movers 12 include an electric motor of any desired specifications or a two-stroke or four-stroke single or multi-cylinder engine. The portable electronic device 18 may be electronically coupled, via one or more wires or wirelessly, to a controller or processor that controls at least one aspect of the prime mover's operation, for example, ignition timing, engine starter or throttle valve position/output speed. Or the device may be independent of and not electrically coupled to any controller of the apparatus 10.

In the example shown in FIG. 1, a handheld apparatus 10 (shown as a string trimmer) includes a body or support 20 on which the tool 14 (e.g. a trimmer head including trimming string), is carried, and on which the engine 12 is carried. That is, the support 20 may generally include all structural parts on which various components of the apparatus 10 are mounted or carried. A mount 22 may also be carried by or on the support 20. Some apparatuses 10 permit connection of different tools 14 (e.g. cutting, trimming, tilling implements) to the support 20 and to the engine 12 such that a single engine 12 and controller/control system may be used for multiple tools 14.

To couple the mount 22 to the support 20, a main body 24 of the mount 22 may include or be connected to a bracket 26 or coupler that is connected to the support 20. In the example shown, the main body 24 includes a two-piece mounting bracket 26 the two-pieces 28, 30 of which are received on opposite sides of a post 31 of the support 20 and coupled together by fasteners or other coupler(s), such as a weld, adhesive, snap-fit, press-fit, interlocking fit or the like. As set forth in more detail below, the mount 22 may also include one or more retaining features between which the electronic device 18 may be removable mounted. At least one of the retaining features may be movable relative to at least one other retaining feature so that the overall size or shape of a mount area 32 may be adjusted or changed. This permits different electronic devices 18 to be removably fitted to the mount 22 within the mount area 32 for use with the apparatus 10.

In the example shown, the mount area 32 is defined at least in part by opposed first and second retaining surfaces 34, 36 and at least one back surface 38 of the main body 24 and/or a second body 40 movably carried by the main body 24. The back surface(s) 38 extend(s) in a first direction and the first and second retaining surfaces 34, 36 may extend outwardly from the back surface 38 in the same direction, generally perpendicular to the back surface 38 (where generally perpendicular includes perpendicular and within fifteen degrees of perpendicular). At least one of the retaining surfaces 34 or 36 and/or the back surface is movable relative to the other surfaces to permit the size and/or shape of the mount area to be adjusted to fit different devices in the mount 22.

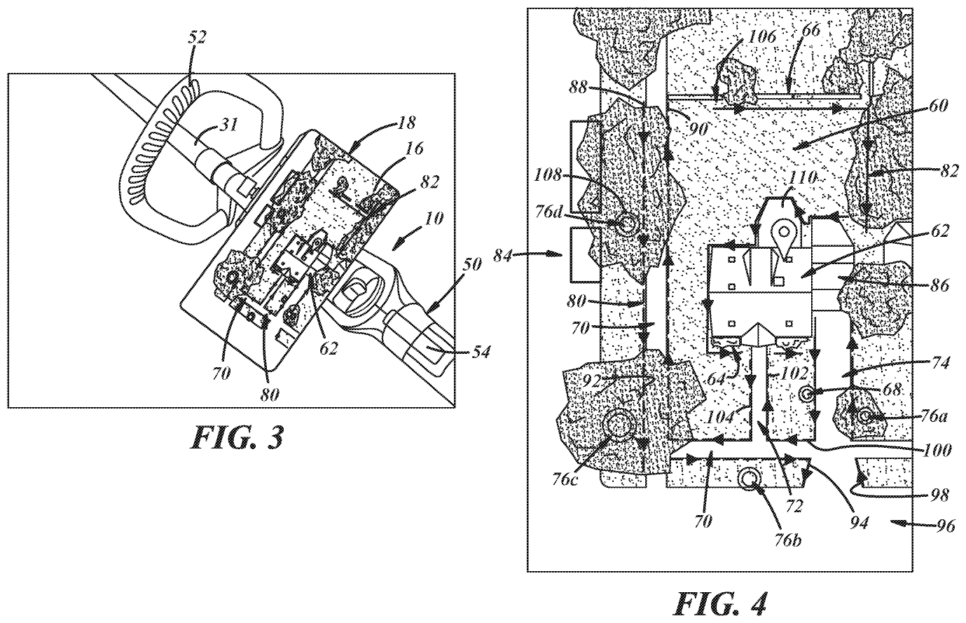

As shown in FIG. 3, many apparatuses 10 have two handles 50, 52 or grip areas spaced apart on the support 20 for the two hands of a user of the apparatus 10. A first handle 50 may include a throttle control 54 to permit user actuation of an engine throttle, and a second handle or grip area 52 may be provided spaced from the first handle 50 for improved control and balance of the apparatus 10 by the user. The mount 22 may be located between the handles or grip areas 50, 52 and oriented at an angle easy viewable by a user of the apparatus 10 while the engine 12 is being started or is in use. Thus, the interactive display 16 or screen of a device 18 received in the mount 22 will be easily viewable by a user of the apparatus 10. In at least some implementations, one of the first and second handles (e.g. handle 50) may be located between the mount 22 and the prime mover 12, and the other handle (e.g. handle 52) may be located between the tool 14 and the mount 22.

As noted above, the display 16 may be part of the portable electronic device 18, such as a phone, tablet or other personal electronic device of the user that is operable for purposes other than control of the apparatus 10/tool 14, or an electronic device custom made for use of the apparatus 10/tool 14 and other similar tools sold by the same or different manufacturers. The electronic device 18 may be secured in the mount 22 as noted above to permit viewing of the display 16 and/or interaction with the display 16, by a user of the apparatus 10. To permit user interaction with the apparatus 10/tool 14 being used, the electronic device 18 may be electronically coupled to the controller of the apparatus 10, by one or more wires (and suitable data and/or power connectors) or wirelessly using any desired wireless protocol, including but not limited to 802.11, other WLAN specifications, WPA, WEP, wireless broadband, Bluetooth or BLE protocol and Wi-fi communication protocols. Such electronic devices 18 typically have memory on which one or more software programs may be stored to control communication between the controller and the electronic device 18, and may have a separate power source such as a battery or may be powered by the electrical power source of the apparatus 10. The device may also include a GPS unit so that the location of the device can be tracked or known.

In FIG. 3, a trimmer 10 is shown in use, sometimes called a string or blade trimmer depending upon the type of cutting implement that is driven for rotation by the prime mover. The cutting implement cuts vegetation, such as grass, plants or weeds, as is known in the art. To facilitate use of the trimmer 10 on the property, the display 16 includes information about the property on which the trimmer 10 is being used, which in this example, is a residential property. The property has one or more areas on which work is to be performed. The areas may include or be defined by borders about which the trimmer is to be used to trim vegetation at the borders, e.g. in areas not sufficiently accessible to a lawn mower. The borders may be defined between a grass lawn 60 and other areas on the property, such as a house 62 and contiguous structures like decks or patios, landscaped areas 64, a fence 66, posts or poles 68 (e.g. electrical pole, light pole or flag pole), paved areas such as a sidewalk 70, front walkway 72 between sidewalk 70 and house 62, a driveway 74, and one or more trees 76a-e or bushes. At least one border or other area of the property may require at least occasional work (e.g. trimming with the trimmer) because a lawn mower or other device does not adequately cut the vegetation (e.g. lawn, plants or weeds) at the border or in the area.

The information on the display 16 may include one or more of text instructions for use of the apparatus 10 at that property, an image, or a computer-generated display which may include or more more icons and/or a map or map features, or some combination of these or other display elements or features. In the particular example shown, the display 16 includes a static, aerial view or photograph of the property, such as a satellite image of the property. The display 16 could instead show the property as it exists on a map, or an image taken from ground-level or from an elevated position such as may be taken by a camera drone. On the display, the borders or areas needing to be trimmed are identified by indicia displayed on the screen in the form of charted walking paths which may include path indicia like lines and/or directional indicia like arrows or pointers, arranged to provide the user with an optimized work path that reduces the total distance traversed by the user which in turn reduces the total time needed to trim the property, reduces the change of failing to perform work on some portion of the property and thereby improves the work product, reduces the amount of gas used, reduces the emissions emitted from the apparatus and reduces the wear on the apparatus.

The work path may include a starting point, an ending point that may be near the starting point, and a routing or path between the starting and ending point that includes or traverses the areas upon which work is to be performed. Different areas of the property may need work done by different tools, for example, an edger may be needed to trim between a paved path 70, 72 and the lawn 60, and a string trimmer may be needed to trim along a border fence 66, landscaped area 62, post 68, tree 76, etc. A work path may be determined and displayed for each tool, and the work paths of multiple tools may be shown on a display 16 together, or separately, as desired. Further, a work path or paths for the entire property may be shown at once, or in discrete segments, as desired. Displaying discrete segments may permit enlarging the view of the segment to be completed to facilitate viewing and understanding of the work path by the user. When a segment is completed, the next segment may automatically appear (e.g. where the user position is known or tracked via GPS system of the electronic device) or the user may select a prompt or menu option to cause the next segment to be displayed.

In the example shown in FIGS. 3 and 4, two work paths are shown on the display. A first work path 80 is provided for a lawn edger and generally traverses the borders between paved areas 70, 72, 74 and the grass lawn 60. A second work path 82 is for a trimmer and generally traverse the borders between the lawn 60 and the house 62, landscaped areas 64, fence 66 and trees 76 on the property. Both work paths 80, 82 may have similar starting and ending points, shown as near a street 84 on which a work vehicle may be parked. Alternatively, the starting and ending points may be near a garage 86 or shed in which the tool(s) are stored. The work paths may be distinguishable in any desired way and by any desired indicia on the display, including having different numbers on the different paths, showing the paths in different colors, etc.

The first work path 80, in the illustrated example, begins at a starting point 88 and flows counterclockwise (as viewed in FIG. 4) and ends at the ending point 90. From the starting point 88, the work path 80 extends along a first side 92 of the main sidewalk 70 until the first side 92 of the sidewalk is intersected by a first side 94 of the driveway 74 whereupon the work path follows the first side of the driveway until it is intersected by a street 96. The work path 80 then moves to a second side 98 of the driveway 74 at the intersection with the street 96 and continues along the second side of the driveway to the house 62, then moves to the first side 94 of the driveway from the house to a second side 100 of the main sidewalk. The work path 80 follows the second side 100 of the main sidewalk 70 until it is intersected by a first side 102 of the front walkway 72 whereupon the path follows the first side of the front walkway to the house 62. The work path 80 then follows a second side 104 of the front walkway 72 back to the second side 100 of the main sidewalk 70 whereupon the work path 80 follows the second side of the main sidewalk to the ending point 90. This route could also be done in reverse, generally clockwise as viewed in FIG. 4. The work path 80 may be shown by lines that are straight or curved to follow a given surface detectable in the image or otherwise known, or by shapes that designate different types of borders. For example, circles may be used for trees 76 or posts 68 as the user needs to walk around the tree trunk or post to complete the work in that area. Other indicia may be used to denote a hedge that needs to be trimmed, a tree that needs to be pruned, or the like.

The second work path 82 is for a trimmer and begins at a starting point 106 along a border fence 66 at the back of the house 62 (a side of the house opposite or other than the driveway 74 and front walkway 72) and extends generally clockwise to an ending point 108 at a tree 76d near the starting point 106. The second work path 82 extends from the starting point 106 along the border fence 66, along the back of the house 62 (e.g. a deck or patio 110 at the back of the house), around a side of the house and across the front of the house, crossing over the front walkway 72. With the fence 66 and house 62 trimmed around, the second work path 82 moves to a post 68 between the driveway 74 and front walkway 72, a first tree 76a outboard of the driveway 74, and to second and third trees 76b and 76c between the main sidewalk and the street 84, ending up at the fourth tree 76d which is closest to the starting point 106 of the second work path 82.

The paths 80, 82 may be somewhat circuitous but arranged to greatly limit or avoid doubling back or having to walk over the same piece of ground multiple times with a single apparatus 10/tool 14. The systematic approach to using the handheld devices also ensures that all areas upon which work is to be performed are included in the path(s) to improve the work product and improve the efficiency of the work. This may enable a new person to perform the work as or nearly as efficiently as a person more familiar with the property to ensure maximum efficiency for work crews and minimum waste of resources.

The optimization of the work path(s) may be done manually by a person seeking to provide instructions to others working at the property, for example an owner or manager of a landscaping company, or an owner seeking to map out the preferred route for his or her own property. The optimization could instead be done via an automated system that analyzes property features via image recognition techniques and provides a strategic routing of the cutting routine, taking into account, accessibility (e.g. whether an obstruction that cannot be crossed is present), average walking speed with the tool being used, starting and ending locations for one or more tools that may be needed to perform the desired work, as well as identified areas needing work. The work path may be displayed along with an indicator of the current position of the device (which may be obtained via the GPS system) so that the progress of the user may be tracked remotely or by the electronic device which may capture the actual path taken by the user and the time taken to complete the entire work path or any portion or portions thereof. This information can be later analyzed or reviewed to provide feedback to the user as to whether they work path actually taken was as efficient as the proposed work path. In addition or instead, the analysis may determine that the determined work path needs to be altered, for example, to take into account an area needing work that was not on the work path. Further, the current position of the user can be compared to a desired position of the user at any time, and an alert or message may be provided to the user if the user is more than a threshold distance from the desired position. This may happen, for example, if the user forgets to perform work at an area needing work and begins to walk away from that area.

In at least some implementations, a method of directing use of a handheld device including a tool which is used to perform work on a property, includes the steps of: analyzing the property to determine at least one area in which work is to be performed; determining a starting point for the work; determining an ending point for the work; determining a work path to be taken by a user between the starting point and the ending point; and communicating the work path to a user of the handheld device. A separate work path may be displayed or provided for each tool for which work is to be performed on the property. Each work path may be displayed simultaneously or one at a time, in their entirety or in any desired segments or portions.

In at least some implementations, the method also includes tracking the position of a user and displaying the position of the user on the display and relative to the work path. The position of the user may be compared to a desired position of the user. And an alert or other indication may be displayed to the user when the user is more than a threshold distance from the desired position. In this way, the position of the user can be maintained along the work path to ensure that the work is performed efficiently. While the illustrated example does not also show a work path for mowing the lawn, the system could likewise calculate and display the preferred work path for a lawn mower or any other device with which a user walks or rides/drives along the property.

Thus, even relatively simple tools, like string trimmers and lawn edgers, which typically do not have a battery and do not have an electronic display capable of showing work paths as set forth herein, can be enabled to provides such information with a portable electronic device, like a mobile phone or tablet, that has its own power source, display, memory and a processor capable of executing a program or instructions stored in the memory. In this way, the use of the simple device can take advantage of the computing power and sophistication of the portable electronics device to improve the efficiency of use of the mobile device, and permit monitoring of the path and performance of a tool by the user or by another person remote from the user (by GPS tracking program, or by a later download of the data from the portable electronic device).

It is to be understood that the foregoing description is not a definition of the invention, but is a description of one or more preferred embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, a method having greater, fewer, or different steps than those shown could be used instead. All such embodiments, changes, and modifications are intended to come within the scope of the appended claims.

As used in this specification and claims, the terms “for example,” “for instance,” “e.g.,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A method of directing use of a handheld device including a tool which is used to perform work on a property, comprising:
analyzing the property to determine at least one area in which work is to be performed;
determining a starting point for the work;
determining an ending point for the work;
determining a work path to be taken by a user between the starting point and the ending point; and
communicating the work path to a user of the handheld device.

2. The method of claim 1 which includes a separate work path for each tool for which work is to be performed on the property.

3. The method of claim 2 wherein each work path is displayed simultaneously on a display.

4. The method of claim 2 wherein the work paths are displayed one at a time on a display.

5. The method of claim 1 which also includes tracking the position of a user and displaying the position of the user on a display and relative to the work path.

6. The method of claim 1 which also includes tracking the position of a user and comparing the tracked position of the user to a desired position of the user.

7. The method of claim 6 wherein an alert is displayed to the user when the user is more than a threshold distance from the desired position.

8. The method of claim 1 which also includes storing to memory the actual path of movement of a user of the device.

9. A handheld apparatus, comprising:
a support including one or more handles arranged to be grasped by a user;
a prime mover carried by the support;
a tool carried by the support and driven by the prime mover; and
a mount carried by the support to receive and releasably retain a portable electronic device having a display and a processor that causes information relating to a work path to be shown on the display for viewing by a user of the apparatus.

10. The apparatus of claim 9 wherein the display includes information about multiple work paths with at least one work path provided for each tool to be used on the property.

11. The apparatus of claim 9 wherein an entire work path is displayed at one time.

12. The apparatus of claim 9 wherein discrete segments of the work path are displayed.

13. The apparatus of claim 9 wherein the device includes a controller that is arranged for wired or wireless connection to the electronic device.

14. The apparatus of claim 13 wherein one of the controller and the electronic device includes a GPS unit or GPS chipset by which the location of the apparatus can be determined.

15. The apparatus of claim 14 wherein the location of the apparatus is shown by an indicator on a display of the electronic device.

16. The apparatus of claim 14 wherein the display includes information about a property at which the apparatus is located.

17. The apparatus of claim 16 wherein the displace includes a computer generated image or a satellite image of the property at which the apparatus is located.

18. The apparatus of claim 9 wherein the work path includes a starting point and an ending point and an optimized path between the starting point and ending point.

19. The apparatus of claim 18 wherein the starting point and ending point are the same location.

20. The apparatus of claim 14 wherein the GPS unit or GPS chipset provides information relating to an actual path of movement of the apparatus.

21. The apparatus of claim 14 which includes memory in which is stored the work path and one or both of the current position of the apparatus or actual path of movement of the apparatus.

22. The apparatus of claim 10 wherein the multiple work paths are provided on the display with different indicia so that the individual work paths can be distinguished from each other.
